(19) United States
(12) Patent Application Publication
(10) Pub. No.: US 2023/0366152 A1
(43) Pub. Date: Nov. 16, 2023

(54) METHOD

(71) Applicant: PA KNOWLEDGE LIMITED, London (GB)

(72) Inventors: Rodney Edward SMITH, Hertfordshire (GB); Craig Harvey NELSON, Hertfordshire (GB); William Frank TYLDESLEY, Hertfordshire (GB); Stuart Michael Ruan JONES, Hertfordshire (GB)

(73) Assignee: PA KNOWLEDGE LIMITED, London (GB)

(21) Appl. No.: 18/027,001

(22) PCT Filed: Sep. 15, 2021
(86) PCT No.: PCT/GB2021/052390

§ 371 Date: Mar. 17, 2023

(30) Foreign Application Priority Data
Sep. 18, 2020 (GB) 2014709.6

(51) Int. Cl. D21H 19/82; D21H 21/16; D21H 19/38; D21H 19/12; D21H 23/72; D21H 23/50; D21H 23/34; D21H 23/44; B65D 65/42; B65D 65/40

(52) U.S. Cl. CPC D21H 19/828; B65D 65/40; B65D 65/42; D21H 19/12; D21H 19/385; D21H 21/16; D21H 23/34; D21H 23/44; D21H 23/50; D21H 23/72; B65D 2565/387

(57) ABSTRACT

A method of barrier coating a porous substrate, the method comprising: coating a surface of the substrate with an intermediate layer, said intermediate layer filling pores at the surface of the substrate; and coating the intermediate layer with a non-polymer barrier layer.

The present disclosure relates to a method of barrier coating a porous substrate. In an embodiment, the substrate is a cellulosic substrate and the barrier coating is a nanometer-scale thick aluminium layer.

Many commercial products rely on barrier materials to maintain product quality freshness and shelf-life. Requirements of barrier coatings include protection against oxygen ingress, moisture ingress or egress and maintenance of aroma, odour and/or flavour. Typically, this is achieved using plastics, such as PE, PP, PET or laminate materials including plastics, such as PE, PP, PET at thicknesses ranging from 10 um to 300 um and/or aluminium foil at thicknesses ranging from 5 um to 50 um.

Synthetic materials, such as PE, PP, PET may present problems with environmental sustainability. Therefore, there is a need to provide effective barrier materials in a different way.

Laminate barrier materials may include card or paper substrates to provide strength and stability, thus reducing the amount of polymeric materials. However, plastics, such as PE, PP, PET are still required to provide barrier properties because such substrates are porous and permeable to gases and moisture.

Attempts have been made to produce barrier materials without materials such as PE, PP, PET. For example, laminate barrier materials including aluminium foil can eliminate the need for plastics, such as PE, PP, PET. However, such barrier materials require a thick layer of aluminium foil, which cannot easily be separated from the substrate. This means that such barrier materials are very difficult to recycle.

Attempts have been made to produce barrier materials without plastics or foil. However, the barrier performance of such materials is generally poor.

It is an aim of the present disclosure to at least partially address some of the problems described above.

According to first aspect of the invention, there is provided a method of barrier coating a porous substrate, the method comprising: coating a surface of the substrate with a thin intermediate layer, said intermediate layer filling pores at the surface of the substrate; and coating the intermediate layer with a non-polymer barrier layer. The non-polymer may be one of: a metal, metal oxide, metal nitride, metal sulphide, carbon based material, silicon, silicon oxide (SiOx), silicon nitride.

Optionally, the substrate is substantially formed from a fibrous material. Optionally, the substrate is substantially formed from a cellulosic material. Optionally, the substrate is substantially formed from a pulp-based material, such as card or paper.

A major problem with using fibrous, cellulosic, paper or card substrates for a barrier material is that the substrate is porous. Such substrates could not previously be coated with ultra-thin barrier layers because the pores in the substrate surface were too large. Providing a thin intermediate layer that fills the pores, reduces the size of the pores and provides a smoother surface for coating . This may improve barrier performance and reduce the required thickness of the final barrier material.

The average pore size of the substrate is preferably no more than 500 um. The average pore size of the substrate is preferably no less than 10 nm. If the pore size is more than 500 nm the intermediate layer may not fill the pores in the substrate as effectively, or the intermediate layer may need to be too thick.

The average pore size after coating with the intermediate layer may be less than 100 nm. Preferably, the average pore size after coating the substrate with the intermediate layer is no more than 10 nm. The average pore size after coating the substrate with the intermediate layer may be no more than 5 nm. Such pore sizes may improve the resultant performance of the barrier coating.

The method may further comprise treating the intermediate layer before coating with the barrier layer to improve adhesion of the barrier layer. The treatment may comprise surface activation of the intermediate layer. The surface activation may be performed using a plasma. The plasma may substantially comprise oxygen or air. Alternatively, the surface activation maybe performed using a corona discharge. These methods may provide particularly effective ways of treating the intermediate layer.

The intermediate layer may have a thickness of no more than 100 um. The intermediate layer may have a thickness of no less than 10 nm. The intermediate layer has a thickness of no more than 50 um. The intermediate layer may have a thickness of no less than 5 um. If the intermediate layer is too thick, material may be wasted. If the intermediate layer is too thin the filling and smoothing properties of the intermediate layer may be reduced.

The method of any preceding claim, wherein the intermediate layer is formed from a material substantially comprising at least one of: a biopolymer, such as PLA, PCL and PBS, PVOH, EVOH, Pullulan, a starch, a natural wax, such as rape seed wax, a natural resin, such as pine resin, and a cellulosic material, such as microfibrous cellulose. Such materials may provide an effective intermediate layer and environmentally sustainable and/or biodegradable and/or compostable barrier material.

The intermediate layer may be applied to the substrate as a fluid, including a liquid, a vapour or a gas. Preferably, the fluid is a solution, preferably an aqueous solution. Accordingly, the material may fill the pores in the substrate effectively and/or provide a sufficiently smooth surface. The intermediate layer may be applied to the substrate by at least one of: printing, dipping, spraying, blade-coating, vapour and gaseous coating and chemical vapour deposition. These are methods that may be particularly effective at applying the intermediate layer.

The intermediate layer may be formed from a plurality of independently formed layers. This may allow the, filling, smoothing and barrier properties of the intermediate layer to be more finely controlled.

The barrier layer may be substantially formed from at least one of: Al, aluminium oxide (AlOx), and silicon oxide (SiOx). These materials may provide particularly effective barrier properties.

The barrier layer preferably has a thickness of no more than 500 nm. The barrier layer preferably has a thickness of no less than 1 nm. The barrier layer may have a thickness of no more than 50 nm. The barrier layer may have a thickness of no less than 5 nm. If the barrier layer is too thick, some environmental benefits may be reduced. If the barrier layer is too thin, barrier performance may be reduced.

The barrier layer may be applied by vacuum deposition, thermal evaporation, reactive thermal evaporation, sputtering, or plasma deposition. Such methods may be particularly effective at applying the barrier layer.

According to a second aspect of the invention there is provided a barrier material comprising: a porous substrate; intermediate layer coating the substrate and filling pores at the surface of the substrate; a metal, metal oxide, or metalloid oxide barrier layer coating the intermediate layer.

The substrate may be substantially formed from a pulp-based material, such as card or paper, the intermediate layer may be formed from a material substantially comprising at least one of: a biopolymer, such as PLA, PCL and PBS, PVOH, EVOH, Pullulan a starch, a natural wax, such as rape seed wax, a natural resin, such as pine resin, and a cellulosic material, such as microfibrous cellulose, and the barrier layer may be substantially formed from at least one of: aluminium, aluminium oxide (AlOx), and silicon oxide (SiOx). Such a combination may provide an environmentally friendly and effective barrier material.

The barrier layer may account for at most 5 wt% of the layered material. This may ensure that the barrier material is readily recyclable, biodegradable and/or compostable.

According to a third aspect of the invention there is provided an article, such as a food or beverage container, formed from the material of the second aspect. Such an article provides an environmentally friendly alternative to existing articles.

Further features of the invention will be described below, by way of non-limiting examples and with reference to the accompanying drawings in which:

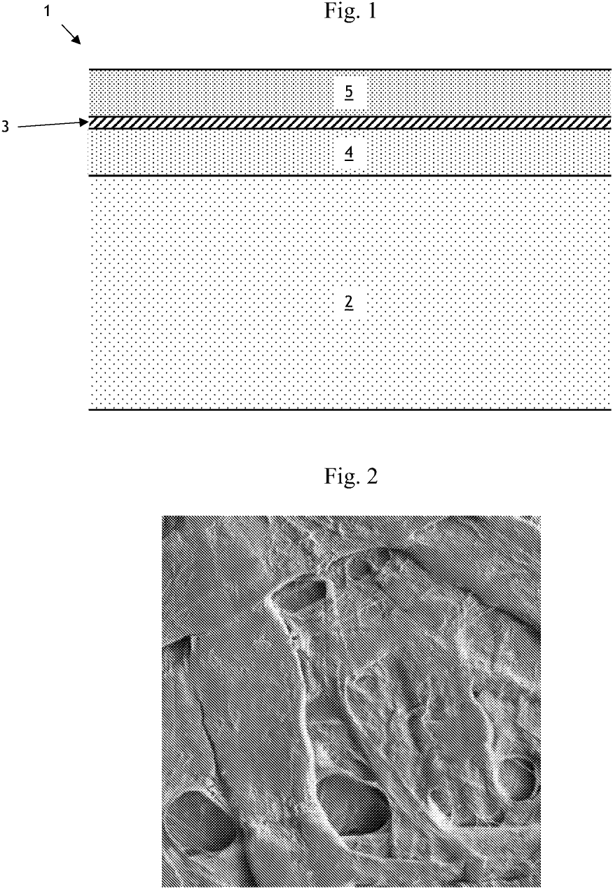

FIG. 1 schematically shows an example barrier material;

FIG. 2 shows a microscope image of an example substrate;

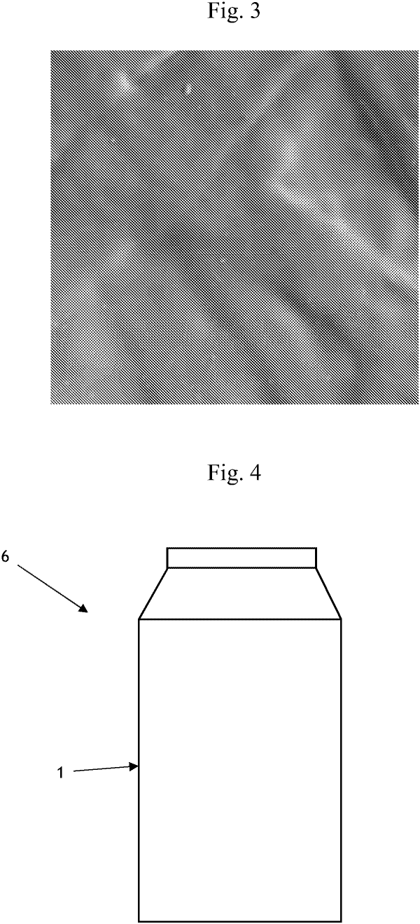

FIG. 3 shows a microscope image of an example substrate coated with an intermediate layer;

FIG. 4 shows an example of an article formed from the barrier material.

An example barrier material 1 is schematically shown in FIG. 1. The barrier material 1 comprises a porous substrate 2. There are many advantages to using porous substrates as a support for a barrier material. In general, porous substrates have a lower density than solid substrates and they require less material. This may reduce the weight of a product making it easier to use, reduce transport costs, and reduce the quantity of resources used during manufacture. Further, porous materials include widely available, sustainable, environmentally friendly materials.

Porous materials include fibrous materials, such as those formed from natural fibres. For example, cellulosic materials are suitable for use as a porous substrate 2. This includes pulp-based materials, such as paper or card, as well as cotton, for example. Other natural fibres, include wool fibres. Accordingly, felts or textiles are also porous materials suitable for use as a barrier material substrate 2. Preferably, the substrate 2 is a cellulosic substrate, more preferably still a pulp-based cellulosic substrate, more preferably still paper or card (e.g. glassine paper).

Possible substrate materials include: cellulose based materials, natural fibre based materials, wool, silk, synthetic fibres based materials, textiles, ceramics, clays, hemp, natural and synthetic rubbers, biopolymers.

The problem with using a porous substrate 2 is that porous substrates do not typically have inherent barrier properties. Accordingly, the barrier material 1 includes a barrier layer 3. The barrier layer 3 is substantially impermeable to gases, such as oxygen, and/or moisture.

As shown in FIG. 1, the barrier material 1 further comprises a barrier layer 3. The barrier layer 3 is configured to provide barrier properties to the barrier material 1. The use of a metal, metal oxide or metalloid oxide layer provides excellent barrier performance at very low thicknesses. For example, barrier layer thicknesses of no more than 500 nm are desirable, more so are thicknesses of between 5 nm and 200 nm or even thicknesses between 5 nm and 50 nm. This may aid recyclability and reduce the consumption of materials. For example, if the barrier layer 3 accounts for at most 5 wt% of the layered material, this may ensure that the barrier material 1 is readily recyclable, biodegradable, and/or compostable.

Preferable materials for the barrier layer 3 include aluminium, aluminium oxide (AlOx) and silicon oxide (SiOx). Possible barrier layer 3 materials also include: carbon based and graphene based materials, silicon, copper, precious metals, including gold, silver, palladium, platinum, rhodium and iridium, other metals, including tin, tungsten, nickel and cobalt, metal oxides, including tin oxide, indium tin oxide, zinc oxide, iron oxide, chromium oxide, titanium oxide and tungsten oxide, metal nitrides, silicon nitride, titanium nitride, metal sulphides including zinc sulphide..

However, prior to the present disclosure, such substrates could not be coated with thin barrier layers because the pores in the substrate surface were too large. Thin barrier layers cannot sufficiently close large pores or cover the substrate surface. FIG. 2 is a x500 microscope image showing the surface of a cellulosic substrate, paper, and illustrating the porous nature of the material. Paper, which is a typical porous substrate material, may have an average pore size of between around 100 nm and around 500 um. More generally though, reduced barrier performance may occur even with pore sizes as low as 10 nm.

Accordingly, the barrier material 1 includes an intermediate layer 4 between the substrate 2 and the barrier layer 3, as shown in FIG. 1. The intermediate layer 4 fills the pores at the surface of the substrate 2. In addition to filling pores, the barrier material may cover the substrate surface, e.g. between pores. This reduces the size of the pores and provides a smoother surface for the barrier layer 3 to coat. FIG. 3 is a x500 microscope image showing the surface of the cellulosic substrate of FIG. 2 that has been filled with PVOH in accordance with the disclosure. In contrast to FIG. 2, FIG. 3 shows a relatively smooth surface. The intermediate layer preferably reduce the size of the pores to no more than 100 nm, preferably still, no more than 10 nm.

The intermediate layer 4 may have a thickness of no more than 100 um and/or no less than 10 nm. More preferably, the intermediate layer 4 may have a thickness of thickness of no more than 50 um and/or no less than 5 um. If the intermediate layer 4 is too thin, the pores may not be filled as effectively and/or the surface may not be as smooth. If the intermediate layer 4 is too thick, material may be wasted and there may also be ecological drawbacks, for example difficulty in recycling.

Suitable materials for the intermediate layer 4 include film-forming materials, such as: Poly Vinyl Alcohol (PVOH), Poly Lactic Acid (PLA) and Pullulan, Cellulose film forming agents: HPMC, Methyl Cellulose, Ethyl Cellulose, Carboxy Methyl Cellulose (CMC), Cellulose Acetate, Films filling porosity: Microfibrillated Cellulose (MFC), Nanofibrillated Cellulose (NFC), Ethylene Vinyl Alcohol (EVOH), Starch based materials, Biopolymers: PBS, PCL, PBAT, PHA, PHB, PHBV, PEF, PA11, PHU, Lignin, Isoprene, Suberin, Melanin, Cutin, Cutan, Lipids, Bio-PE, Bio-PP and Bio-PET, Gelatin, Casein, Alginates, Natural Waxes: Rape Seed, Rice, Bees, Carnauba, Candelilla Waxes, Natural Resins: Pine Resin, Natural Gums: Xanthan, Gum Arabic, Natural Proteins: Zein, Whey, Polysaccharides, Polyvinyl Acetate (PVA), Synthetics Waxes: Paraffin, PEGs, MPEGs, Synthetic Glues: Epoxys and Cyanoacrylates, Polyolefin Dispersions, Acrylates, Epoxys, Polyesters, Polyurethanes, Parylenes, Silanes, Polyacrylonitriles (PANs), Polyamides, Polyvinylacetates (PVAs), Silicones, Stryrenes, PVDC, Fluorohydrocarbons, Chitin and Chitosan, Synthetic polymers PE, PP, PET (as Ultra-thin low level coatings). For example, PVOH and EVOH have particularly low oxygen transmission rates. Combinations of these materials may be used, e.g. blends. Preferably, the intermediate layer 4 is formed from a natural material, such as: a biopolymer, such as PLA, PCL and PBS, a starch, PVOH, EVOH, Pullulan, BVOH, a natural wax, such as rape seed wax, a natural resin, such as pine resin, and a cellulosic material, such as microfibrous cellulose.

In some examples, the intermediate layer 4 may be formed from a plurality of independently formed layers, e.g. of differing materials. Accordingly, the benefits of each layer can be combined.

The intermediate layer 4 may be formed as a fluid, e.g. liquid, gel, dispersion, colloid or vapour. This may enable the intermediate layer 4 to flow into the pores and more effectively fill the pores. This may also help to provide a smoother surface for the barrier layer 3 to adhere to. Preferably, the intermediate layer is formed as a solution or suspension, preferably an aqueous solution or suspension. The intermediate layer 4 may be applied by methods such as printing, dipping, spraying, blade-coating, vapour or gaseous coating and/or chemical vapour deposition. Most preferable are spray, blade coating, printing and vapour coating.

In order to improve adhesion between the intermediate layer 4 and the barrier layer 3, the intermediate layer 4 may be subject to surface treatment prior to coating with the barrier layer 3. Oxygen plasma activation is one preferred treatment. However other types of treatment, including surface activation, e.g. using alternative plasmas such as air, argon, nitrogen, neon or mixtures of these gases may be used instead. Alternatively, activation may be performed using corona discharge.

The use of an intermediate layer 4 as described above allows a thin barrier layer 3 to be applied. For example, the barrier layer materials described above can be applied with the desired thicknesses of no more than 500 nm, between 5 nm and 200 nm or even thicknesses between 5 nm and 50 nm. The barrier layer 3 may be formed by a process of vacuum deposition in order to achieve an ultra-thin layer. The vacuum deposition is preferable physical vapour deposition. However, other coating methods may be used.

FIG. 1 additionally shows an optional top layer 5. Although, the term “top layer” is used, a final product may include further layers covering the top layer 5. The top layer 5 may provide protection to the barrier layer 3 and/or provide additional barrier properties. The top layer can also provide other functional properties like heat sealability, chemical and mechanical protection of the barrier layer and constituent materials, a cold and hot water or liquid repellent barrier, additional gas barrier, decoration, printing or branding information. Suitable material for the top layer 5 include: Biopolymer materials, Synthetic polymers, Natural materials such as waxes, resins, proteins and gums, Acrylates, Polyesters, Epoxys, PET, Polyurethanes, Styrenes, Parylenes, Silane coatings, Silicone based coatings, Polyolefin coatings, Gel, Dispersion or Colloid based coatings, PLA, PBS, PCL, PBAT or other Biopolymer Dispersion coatings, Cellulose based materials, Sol-gel based coatings, Synthetics Waxes: Paraffin, PEGs, MPEGs, Polysaccharides, Chitin and Chitosan, Vapour deposited and CVD coatings, Glass, Clay and Ceramic based coatings.

The barrier material 1 may optionally include further layers, in addition to those described above. For example, a second layer of the substrate material may be provided opposite the substrate 2, relative to the intermediate layer 4 and barrier layer 3. In other words, the intermediate layer 4 and barrier layer 3 may be sandwiched between two layers of the substrate.

In an example, glassine paper was coated with 15 gsm dried weight of PVOH sputtered with Al around 200 nm thick. Helium permeation testing of the treated glassine showed a transmission range of 8 × 10⁹ to 1.34 × 10⁸ atm/cc/sec. In direct comparison Helium testing of Walkers™ branded crisp packaging showed a transmission range of 8.6 × 10⁸ to 2×10⁷ atm/cc/sec. These results show that the sputtered PVOH material can be used across a range of dried food packaging applications.

As in the example above, the 15gsm layer of PVOH may be applied b coating the substrate (glassine paper) with two layers of 15% solution of PVOH, e.g. using a Mayer bar.

The barrier material 1 may be formed as a sheet. The sheet may then be formed into specific articles in a standard way, such as the carton shown in FIG. 4. As the intermediate layer 4, barrier layer 3 and optional top layer 5 are thin characteristics of the substrate 2 such as the ability to bend or be folded may not be substantially altered. Examples of articles include: cartons, boxes, bottles, sachets, packets (e.g. of the type suitable for biscuits crisps or confectionary), coffee capsules, blister packs, tubes (e.g. of the type suitable for toothpaste or cosmetic creams).

It should be understood that variations on the above described examples are possible within the spirit and scope of the invention, which is defined by the appended claims.

1. A method of barrier coating a porous substrate, the method comprising:
coating a surface of the substrate with an intermediate layer, said intermediate layer filling pores at the surface of the substrate; and
coating the intermediate layer with a non-polymer barrier layer.

2. The method of claim 1, wherein the non-polymer is one of: a metal, metal oxide, metal nitride, metal sulphide, carbon based material, silicon, silicon oxide (SiOx), silicon nitride.

3. The method of claim 1 or 2, wherein the substrate is substantially formed from a fibrous material.

4. The method of claim 3, wherein the substrate is substantially formed from a cellulosic material.

5. The method of claim 4, wherein the substrate is substantially formed from a pulp-based material, such as card or paper.

6. The method of any preceding claim, wherein the average pore size of the substrate is no more than 500 um and/or no less than 1 nm.

7. The method of any preceding claim, wherein the average pore size after coating the substrate with the intermediate layer is less than 100 nm.

8. The method of any preceding claim, further comprising treating the intermediate layer before coating with the barrier layer, said treatment configured to improve adhesion of the barrier layer.

9. The method of claim 8, wherein the treatment comprises surface activation of the intermediate layer.

10. The method of claim 9, wherein the surface activation is performed using a plasma.

11. The method of claim 10, wherein the plasma substantially comprises oxygen or air.

12. The method of any preceding claim, wherein the intermediate layer has a thickness of no more than 100 um and/or no less than 10 nm.

13. The method of claim 12, wherein the intermediate layer has a thickness of no more than 50 um and/or no less than 5 um.

14. The method of any preceding claim, wherein the intermediate layer is formed from a material substantially comprising at least one of: a biopolymer, such as PLA, PCL and PBS, a starch, PVOH, EVOH, Pullulan, BVOH, a natural wax, such as rape seed wax, a natural resin, such as pine resin, and a cellulosic material, such as microfibrous cellulose.

15. The method of any preceding claim, wherein the intermediate layer is applied to the substrate as a fluid.

16. The method of claim 16, wherein the fluid is an aqueous solution, suspension, gel, dispersion or colloid.

17. The method of any preceding claim, wherein the intermediate layer is applied to the substrate by at least one of: printing, dipping, spraying, blade-coating, vapour or gaseous coating and chemical vapour deposition.

18. The method of any preceding claim, wherein the barrier layer is substantially formed from at least one of: aluminium, aluminium oxide (AlOx), and silicon oxide (SiOx).

19. The method of any preceding claim wherein the barrier layer has a thickness of no more than 500 nm.

20. The method of any preceding claim wherein the barrier layer has a thickness of no more than 50 nm and/or no less than 5 nm.

21. The method of any preceding claim, wherein the barrier layer is applied by vacuum deposition, such as thermal evaporation, reactive thermal evaporation or sputtering.

22. A barrier material comprising:
a porous substrate;
intermediate layer coating the substrate and filling pores at the surface of the substrate;
a non-polymer barrier layer coating the intermediate layer.

23. The barrier material of claim 22, wherein:
the substrate is substantially formed from a pulp-based material, such as card or paper,
the intermediate layer is formed from a material substantially comprising at least one of: a biopolymer, such as PLA, PCL and PBS, a starch, PVOH, EVOH, Pullulan, BVOH, a natural wax, such as rape seed wax, a natural resin, such as pine resin, and a cellulosic material, such as microfibrous cellulose, and
the barrier layer is substantially formed from at least one of: aluminium, aluminium oxide (AlOx), and silicon oxide (SiOx).

24. The barrier material of claim 22 or claim 23, wherein the barrier layer accounts for at most 5 wt% of the barrier material.

25. An article, such as a food or beverage container, formed from the barrier material of any one of claims 22 to 24.
